(19) United States
(12) Patent Application Publication
(10) Pub. No.: US 2019/0138606 A1
(43) Pub. Date: May 9, 2019

(54) NEURAL NETWORK-BASED TRANSLATION METHOD AND APPARATUS

(71) Applicant: HUAWEI TECHNOLOGIES CO., LTD., Shenzhen (CN)

(72) Inventors: Zhaopeng TU, Shenzhen (CN); Hang LI, Shenzhen (CN); Wenbin JIANG, Beijing (CN)

(21) Appl. No.: 16/241,700

(22) Filed: Jan. 7, 2019

Related U.S. Application Data
(63) Continuation of application No. PCT/CN2017/077950, filed on Mar. 23, 2017.

(30) Foreign Application Priority Data
Jul. 12, 2016 (CN) 201610545902.2

(51) Int. Cl. G06F 17/28; G06N 3/04; G06F 17/27

(52) U.S. Cl. CPC G06F 17/289; G06F 17/2845; G06F 17/2785; G06N 3/0454

(57) ABSTRACT

Disclosed embodiments include a neural network-based translation method, including: splitting the unknown word in an initial translation into one or more characters, and inputting, into a first multi-layer neural network, a character sequence constituted by the one or more characters ; obtaining a character vector of each character in the character sequence by using the first multi-layer neural network, and inputting all character vectors in the character sequence into a second multi-layer neural network; encoding all the character vectors by using the second multi-layer neural network and a preset common word database, to obtain a semantic vector; and inputting the semantic vector into a third multi-layer neural network, decoding the semantic vector by using the third multi-layer neural network, and determining a final translation of the to-be-translated sentence based on the initial translation of the to-be-translated sentence.

### CROSS-REFERENCE TO RELATED APPLICATIONS

This application is a continuation of International Application No. PCT/CN2017/077950, filed on Mar. 23, 2017, which claims priority to Chinese Patent Application No. 201610545902.2, filed on Jul. 12, 2016. The disclosures of the aforementioned applications are hereby incorporated by reference in their entireties.

### TECHNICAL FIELD

The present disclosure relates to the field of communications technologies, and in particular, to a neural network-based translation method and apparatus.

### BACKGROUND

In a current statistical machine translation process, a translation model of statistical machine translation is obtained from training data through automatic learning. Therefore, for a word that does not appear in a training corpus of the translation model, a translation corresponding to the word cannot be generated by using the translation model, resulting in a phenomenon of an unknown word. The unknown word is a word that does not appear in the training corpus of the translation model, and a result of translating the unknown word by using the translation model is usually outputting the raw unknown word or outputting “unknown (UNK)”. In statistical machine translation, particularly in cross-field (for example, a translation model obtained from a training corpus of a news field is used for translation in a communications field) machine translation, because the training corpus of the translation model is difficult to cover all vocabularies, a probability that the raw unknown word is output in a machine translation result is high, and a translation effect is poor.

In the prior art, in a first manner, the training corpus can cover more linguistic phenomena by enriching the training corpus, to improve accuracy of machine translation and reduce a probability of appearance of an unknown word. However, enriching the training corpus requires more word resources and manual participation of more bilingual experts. Consequently, implementation costs are high and operability is poor.

In the prior art, in a second manner, a dictionary is used for direct translation or indirect translation to find, from the dictionary, an unknown word or a word whose semantics is similar to that of an unknown word, so as to determine a meaning of the unknown word by using the dictionary. However, difficulty of constructing a bilingual dictionary or a semantic dictionary is not lower than difficulty of constructing a bilingual training corpus, and the dictionary further needs to be updated and maintained in a timely manner during use of the dictionary. Update frequency of a new word in network text data is high, operability of updating and maintaining the dictionary in a timely manner is poor, and it is difficult in implementation. Consequently, machine translation with the help of the dictionary is difficult in implementation, and costs are high.

### SUMMARY

This application provides a neural network-based translation method and apparatus, to improve translation operability of an unknown word, reduce translation costs of machine translation, and improve translation quality of machine translation.

A first aspect provides a neural network-based translation method. The method may include:

obtaining an initial translation of a to-be-translated sentence, where the initial translation carries an unknown word;

splitting the unknown word in the initial translation into one or more characters, and inputting, into a first multi-layer neural network, a character sequence constituted by the one or more characters that is obtained by splitting the unknown word, where the character sequence includes at least one character;

obtaining a character vector of each character in the character sequence by using the first multi-layer neural network, and inputting all character vectors in the character sequence into a second multi-layer neural network;

encoding all the character vectors by using the second multi-layer neural network and a preset common word database, to obtain a semantic vector corresponding to the character sequence; and

inputting the semantic vector into a third multi-layer neural network, decoding the semantic vector by using the third multi-layer neural network, and determining a final translation of the to-be-translated sentence based on the initial translation of the to-be-translated sentence, where the final translation carries a translation of the unknown word.

This application can improve translation operability of an unknown word, reduce costs of machine translation, improve accuracy of machine translation, and further improve translation quality.

With reference to the first aspect, in a first possible implementation, the preset common word database includes at least one of a dictionary, a linguistics rule, and a cyberword database.

In this application, the common word database may be used to improve accuracy of word combination and reduce noise of determining a meaning of the semantic vector corresponding to the character sequence.

With reference to the first aspect or the first possible implementation of the first aspect, in a second possible implementation, the encoding all the character vectors by using the second multi-layer neural network and a preset common word database, to obtain a semantic vector corresponding to the character sequence includes:

determining at least one combination manner of the character vectors in the character sequence by using the second multi-layer neural network based on vocabulary information provided by the common word database, where a character vector combination determined by each combination manner corresponds to one meaning; and

compression encoding at least one meaning of at least one character vector combination determined by the at least one combination manner, to obtain the semantic vector.

This application can improve accuracy of word combination, reduce noise of determining a meaning of the semantic vector corresponding to the character sequence, and improve translation efficiency.

With reference to the second possible implementation of the first aspect, in a third possible implementation, the decoding the semantic vector by using the third multi-layer neural network, and determining a final translation of the to-be-translated sentence based on the initial translation of the to-be-translated sentence includes:

decoding the semantic vector by using the third multi-layer neural network, to determine at least one meaning included in the semantic vector, and selecting, based on a context meaning of the unknown word in the initial translation, a target meaning from the at least one meaning included in the semantic vector; and

determining the final translation of the to-be-translated sentence based on the target meaning and the context meaning of the unknown word in the initial translation.

In this application, the semantic vector is decoded by using the multi-layer neural network, and a meaning of the unknown word is determined based on the context meaning of the unknown word, to improve translation accuracy of the unknown word and improve translation quality.

With reference to any one of the first aspect to the third possible implementation of the first aspect, in a fourth possible implementation, the unknown word includes at least one of an abbreviation, a proper noun, a derivative, and a compound word.

In this application, the unknown word in a plurality of forms can be translated, to improve applicability of the translation method and enhance user experience of a translation apparatus.

A second aspect provides a neural network-based translation apparatus. The apparatus may include:

an obtaining module, configured to obtain an initial translation of a to-be-translated sentence, where the initial translation carries an unknown word;

a first processing module, configured to: split the unknown word in the initial translation obtained by the obtaining module into one or more characters, and input, into a first multi-layer neural network, a character sequence constituted by the one or more characters that is obtained by splitting the unknown word, where the character sequence includes at least one character;

a second processing module, configured to: obtain, by using the first multi-layer neural network, a character vector of each character in the character sequence input by the first processing module, and input all character vectors in the character sequence into a second multi-layer neural network;

a third processing module, configured to: encode, by using the second multi-layer neural network and a preset common word database, all the character vectors input by the second processing module, to obtain a semantic vector corresponding to the character sequence; and

a fourth processing module, configured to: input the semantic vector obtained by the third processing module into a third multi-layer neural network, decode the semantic vector by using the third multi-layer neural network, and determine a final translation of the to-be-translated sentence based on the initial translation of the to-be-translated sentence, where the final translation carries a translation of the unknown word.

With reference to the second aspect, in a first possible implementation, the preset common word database includes at least one of a dictionary, a linguistics rule, and a cyberword database.

With reference to the second aspect or the first possible implementation of the second aspect, in a second possible implementation, the third processing module is configured to:

determine at least one combination manner of the character vectors in the character sequence by using the second multi-layer neural network based on vocabulary information provided by the common word database, where a character vector combination determined by each combination manner corresponds to one meaning; and

compression encode at least one meaning of at least one character vector combination determined by the at least one combination manner, to obtain the semantic vector.

With reference to the second possible implementation of the second aspect, in a third possible implementation, the fourth processing module is configured to:

decode, by using the third multi-layer neural network, the semantic vector obtained by the third processing module, to determine at least one meaning included in the semantic vector, and select, based on a context meaning of the unknown word in the initial translation, a target meaning from the at least one meaning included in the semantic vector; and

determine the final translation of the to-be-translated sentence based on the target meaning and the context meaning of the unknown word in the initial translation.

With reference to any one of the second aspect to the third possible implementation of the second aspect, in a fourth possible implementation, the unknown word includes at least one of an abbreviation, a proper noun, a derivative, and a compound word.

This application can improve translation operability of an unknown word, reduce costs of machine translation, improve accuracy of machine translation, and further improve translation quality.

A third aspect provides a terminal. The terminal may include a memory and a processor, and the memory is connected to the processor.

The memory is configured to store a group of program code.

The processor is configured to invoke the program code stored in the memory, to perform the following operations:

obtaining an initial translation of a to-be-translated sentence, where the initial translation carries an unknown word;

splitting the unknown word in the initial translation into one or more characters, and inputting, into a first multi-layer neural network, a character sequence constituted by the one or more characters that is obtained by splitting the unknown word, where the character sequence includes at least one character;

obtaining a character vector of each character in the character sequence by using the first multi-layer neural network, and inputting all character vectors in the character sequence into a second multi-layer neural network;

encoding all the character vectors by using the second multi-layer neural network and a preset common word database, to obtain a semantic vector corresponding to the character sequence; and

inputting the semantic vector into a third multi-layer neural network, decoding the semantic vector by using the third multi-layer neural network, and determining a final translation of the to-be-translated sentence based on the initial translation of the to-be-translated sentence, where the final translation carries a translation of the unknown word.

With reference to the third aspect, in a first possible implementation, the preset common word database includes at least one of a dictionary, a linguistics rule, and a cyberword database.

With reference to the third aspect or the first possible implementation of the third aspect, in a second possible implementation, the processor is configured to:

determine at least one combination manner of the character vectors in the character sequence by using the second multi-layer neural network based on vocabulary information provided by the common word database, where a character vector combination determined by each combination manner corresponds to one meaning; and

compression encode at least one meaning of at least one character vector combination determined by the at least one combination manner, to obtain the semantic vector.

With reference to the second possible implementation of the third aspect, in a third possible implementation, the processor is configured to:

decode the semantic vector by using the third multi-layer neural network, to determine at least one meaning included in the semantic vector, and select, based on a context meaning of the unknown word in the initial translation, a target meaning from the at least one meaning included in the semantic vector; and

determine the final translation of the to-be-translated sentence based on the target meaning and the context meaning of the unknown word in the initial translation.

With reference to any one of the third aspect to the third possible implementation of the third aspect, in a fourth possible implementation, the unknown word includes at least one of an abbreviation, a proper noun, a derivative, and a compound word.

This application can improve translation operability of an unknown word, reduce costs of machine translation, improve accuracy of machine translation, and further improve translation quality.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic flowchart of a neural network-based translation method according to an embodiment of the present disclosure;

FIG. 2 is a schematic diagram of performing feature learning on a vocabulary by using a neural network;

FIG. 3a is a schematic diagram of determining a semantic vector by using a plurality of character vectors;

FIG. 3b is another schematic diagram of determining a semantic vector by using a plurality of character vectors;

FIG. 4 is a schematic diagram of translation processing of an unknown word;

FIG. 5 is a schematic structural diagram of a neural network-based translation apparatus according to an embodiment of the present disclosure; and

FIG. 6 is a schematic structural diagram of a terminal according to an embodiment of the present disclosure.

### DESCRIPTION OF EMBODIMENTS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

With development of economic globalization and explosive growth of network text data brought by rapid development of the Internet, information communication and information exchange between different countries become increasingly frequent. In addition, the booming Internet greatly facilitates information communication and information exchange in various languages such as English, Chinese, French, German, and Japanese. Language data in diverse forms brings a good opportunity for development of statistical machine translation. A neural network-based translation method and apparatus provided in the embodiments of the present disclosure are applicable to an inter-translation operation between Chinese information and information in another language form. This is not limited herein. An example in which Chinese is translated into English is used below to describe the neural network-based translation method and apparatus provided in the embodiments of the present disclosure.

An important problem in statistical machine translation is an unknown word. In statistical machine translation, a translation result of the unknown word is outputting the raw unknown word or “unknown (UNK)”, greatly affecting translation quality.

The unknown word may include a plurality of types of words, and may include at least the following five types of words:

(1) an abbreviation, for example, “China Railway Engineering Corporation” (CREC), the Two Sessions (“the National People's Congress of the People's Republic of China” and “the Chinese People's Political Consultative Conference”), or “Asia-Pacific Economic Cooperation” (APEC);

(2) a proper noun, which may include a person name, a place name, an organization name, or the like;

(3) a derivative, which may include a word with a suffix morpheme, for example, “informatization”;

(4) a compound word, including two or more phrases, for example, “weather forecaster” and “weatherman”; and

(5) a numeric compound word, that is, a compound word with a number. Because of a large quantity and strong regularity of such words, such words are listed as a single type.

For translation of an unknown word, in the prior art, a training corpus can cover more linguistic phenomena by enriching the training corpus, to improve accuracy of machine translation and reduce a probability of appearance of an unknown word. However, a machine translation corpus is a parallel sentence pair, and constructing a parallel sentence pair corpus requires a bilingual expert, incurring considerable time costs and economic costs. In addition, for a specific field (for example, the communications field), a corresponding translation corpus is difficult to find due to limited resources. Due to this limitation, it is difficult to enlarge a parallel sentence pair corpus of machine translation, and a growth speed of the parallel sentence pair corpus is relatively slow. For some words that have relatively low use frequency in a language (such as rare words), enlarging a corpus cannot enable frequency of some words to increase on a large scale, and the frequency is still very low. Therefore, in the prior art, a solution of enriching a training corpus has high costs and poor operability.

If a dictionary is used to directly translate an unknown word, a bilingual dictionary is required. When the unknown word is encountered in a translation process, a translation corresponding to the unknown word is obtained by looking up the bilingual dictionary. In this manner, the dictionary with a relatively large scale is required to effectively overcome a shortage of a training corpus. However, difficulty of constructing the bilingual dictionary is not lower than difficulty of constructing a bilingual training corpus, and the dictionary further needs to be updated and maintained in a timely manner during use of the dictionary, and therefore relatively high implementation costs are incurred.

If a dictionary is used to indirectly translate an unknown word, a monolingual synonym dictionary is required. For example, literature (Keyan Zhou, Chengqing Zong. Method for handling unknown words in a Chinese-English statistical translation system; Zhang J, Zhai F, Zong C. Handling unknown words in statistical machine translation from a new perspective.—Handling unknown words in statistical machine translation from a new perspective) proposes to use Chinese synonym knowledge to explain semantics of an unknown word, enabling the unknown word to have a preliminary meaning disambiguation capability. This method can overcome a shortage of a training corpus to some extent. However, difficulty of constructing the monolingual dictionary is not lower than difficulty of constructing a bilingual training corpus, and the dictionary further needs to be updated and maintained in a timely manner during use of the dictionary, and therefore relatively high implementation costs are incurred.

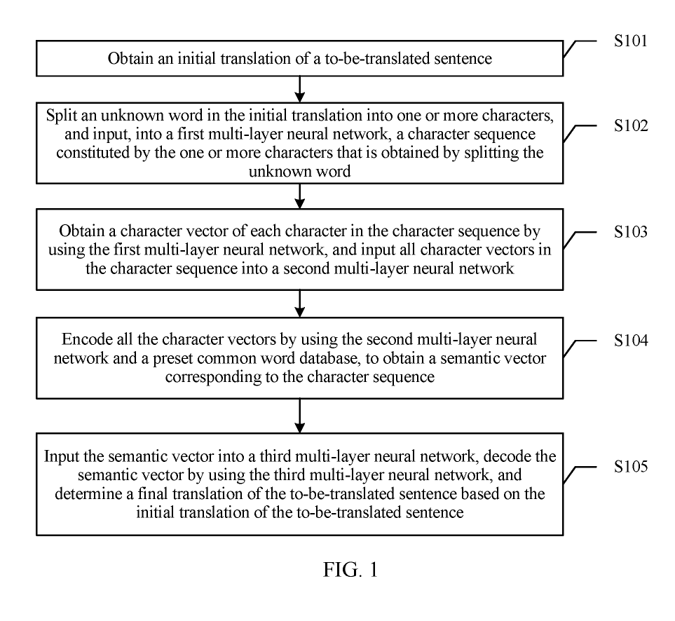

To resolve a problem of constructing the bilingual training corpus and a problem of constructing the dictionary, the embodiments of the present disclosure provide a neural network-based translation method and apparatus. The neural network-based translation method and apparatus provided in the embodiments of the present disclosure are described below with reference to FIG. 1 to FIG. 6.

FIG. 1 is a schematic flowchart of a neural network-based translation method according to an embodiment of the present disclosure. The method provided in this embodiment of the present disclosure includes the following operations.

S101. Obtain an initial translation of a to-be-translated sentence.

In some implementations, the neural network-based translation method provided in this embodiment of the present disclosure may be performed by a terminal such as a smartphone, a tablet computer, a notebook computer, or a wearable device or a processing module in a terminal. This is not limited herein. The terminal or the processing module in the terminal may be a function module added to an existing statistical machine translation system, and is configured to process translation of an unknown word (the following uses an unknown word processing apparatus as an example for description). A statistical machine system provided in this embodiment of the present disclosure includes an unknown word processing apparatus and an existing translation apparatus. In an implementation, the statistical machine system may further include more other modules, and the other modules may be determined based on an actual application scenario. This is not limited herein. The existing translation apparatus may be configured to correctly translate a sentence that does not include an unknown word, and when translating a sentence that includes an unknown word, the translation apparatus outputs the raw unknown word or outputs unknown or the like.

In some implementations, when a user needs to translate the to-be-translated sentence by using the statistical machine system, the user may input the to-be-translated sentence into the statistical machine system. The statistical machine system translates the to-be-translated sentence by using the translation apparatus, and outputs the initial translation of the to-be-translated sentence. If the to-be-translated sentence that the user needs to translate does not include an unknown word, the initial translation is a final translation of the to-be-translated sentence. Details are not described in this embodiment of the present disclosure. If the to-be-translated sentence includes an unknown word, the initial translation is a sentence that carries the unknown word. In this embodiment of the present disclosure, a translation processing process of the to-be-translated sentence that includes any one or more of the foregoing types of unknown words is described.

In an implementation, the unknown word processing apparatus may obtain the initial translation obtained by translating the to-be-translated sentence by the translation apparatus, and the initial translation includes the unknown word. To be specific, when translating the to-be-translated sentence, the translation apparatus may output the raw unknown word to obtain the initial translation, or may output the unknown word as unknown and add information about the unknown word to the initial translation. In an implementation, a form of outputting the initial translation by the translation apparatus may be determined based on a translation manner used in actual application. This is not limited herein.

S102. Split an unknown word in the initial translation into one or more character, and input, into a first multi-layer neural network, a character sequence constituted by the one or more characters that is obtained by splitting the unknown word.

In some implementations, after obtaining the initial translation of the to-be-translated sentence, the unknown word processing apparatus may obtain the unknown word from the initial translation through parsing. The unknown word includes one or more characters. Further, the unknown word processing apparatus may split the unknown word in the initial translation into the character, use the character obtained by splitting the unknown word to constitute a sequence, referred to as the character sequence, and further input the character sequence into the first multi-layer neural network. If the unknown word is a one-character word, the character sequence is a sequence that includes one character. If the unknown word is an N-character word, the character sequence is a sequence that includes N characters, and N is an integer greater than 1. For example, if the unknown word is “ [symbol] ”, the “ [symbol] ” may be split into five characters: “ [symbol] ”, “ [symbol] ”, “ [symbol] ”, “ [symbol] ”, and “ [symbol] ”, and further the five characters may constitute one character sequence, for example, “ [symbol] ”. A line “-” in the character sequence is merely used to indicate that the five characters are not one word but one character sequence, does not have another specific meaning, and is not input into the first multi-layer neural network as a character. A character is a smallest language unit in Chinese processing, and there is no phenomenon of “unknown” in Chinese. Therefore, processing of an unknown word may be converted into processing of a character. In another language pair, a vocabulary may also be processed in a splitting manner, and an unknown word is split into a plurality of smallest semantic units. For example, a word in English may be split into a smallest semantic unit such as a plurality of letters or roots. A splitting manner may be determined based on composition of a word. This is not limited herein.

In a translation method that is based on a word splitting granularity for adjustment and that is included in the prior art, an unknown word such as a compound word or a derivative is split into a plurality of common words, and processing of the unknown word is converted into processing of the common word. For example, an unknown word “ [symbol] ”is split into “ [symbol] ” and “ [symbol] ”, and translation of “ [symbol] ” is implemented by translating “ [symbol] ” and “ [symbol] ”. Literature (Zhang R, Sumita E. Chinese Unknown Word Translation by Subword Re-segmentation) believes that a Chinese word is a character sequence. A part of a word is extracted to obtain a subword (English: subword, between a word and a phrase), an unknown word is translated by using a subword-based translation model, and unknown words of a non-compound type and a non-derived type may be identified. This achieves a particular effect in an experiment. However, this implementation is merely applicable to a compound word and a derivative, and cannot be applied to an unknown word in more forms. In addition, if an unknown word is split into a plurality of words, it is difficult to control a word spitting granularity. If the word spitting granularity is very fine, noise is introduced, and a translation system capability is reduced. If the word spitting granularity is very coarse, a compound word cannot be effectively parsed. In addition, a word spitting method is usually a statistical method. This is separate from semantics, easy to generate a spitting error, and has low applicability.

5103. Obtain a character vector of each character in the character sequence by using the first multi-layer neural network, and input all character vectors in the character sequence into a second multi-layer neural network.

In some implementations, a discrete word may be vectorized through deep learning for widespread use in the natural language processing field. In depth learning-based natural language processing, a vocabulary is expressed in a one-hot form. To be specific, it is assumed that a vocabulary table includes V words. A K^{th} word may be represented as a vector with a size of V, a K^{th} dimension is 1, other dimensions are 0, and this vector is referred to as a one-hot vector. For example, there is a vocabulary table (we, I, love, China), and a size is 4 (namely, V=4). In this case, a vector corresponding to the word we is represented as (1, 0, 0, 0). A vector in which there is only one element 1 and other elements are 0 is referred to as a one-hot vector. (1, 0, 0, 0) indicates that the word is a first word in the vocabulary table. Likewise, the word I may be represented as (0, 1, 0, 0), indicating a second word in the vocabulary table.

The foregoing representation manner of depth learning-based natural language processing cannot effectively describe semantic information of a word. To be specific, regardless of a correlation between two words, one-hot vectors of the two words are orthogonal. This has low applicability. For example, vectors of the word “we” and the word “I” are respectively represented as (1, 0, 0, 0) and (0, 1, 0, 0), (1, 0, 0, 0) and (0, 1, 0, 0) are orthogonal vectors, and a relationship between the word we and the word I cannot be learned from the vectors. In addition, the foregoing representation manner of depth learning-based natural language processing also easily causes data sparsity. When different words are applied to a statistical model as entirely different features, because a quantity of appearance times of an uncommon word in training data is relatively small, an estimation deviation of a corresponding feature is caused.

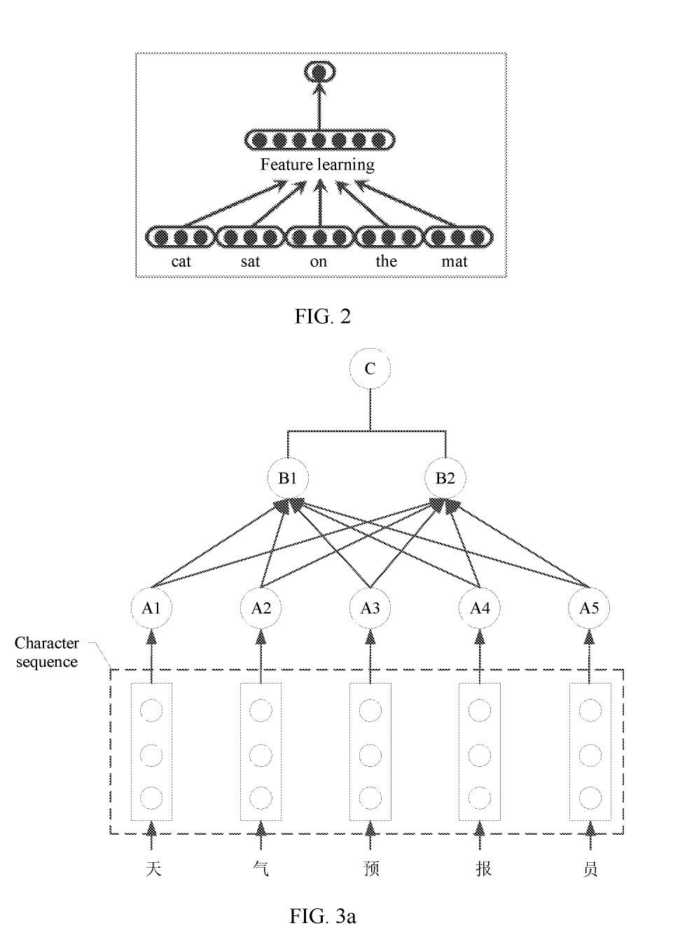

In some implementations, in this embodiment of the present disclosure, a neural network method is used to automatically learn vectorization representation of a vocabulary, and a specific meaning of a polysemant in a sentence is determined based on a location of the polysemant in the sentence or a context of the sentence. FIG. 2 is a schematic diagram of performing feature learning on a vocabulary by using a neural network. Each word in a vocabulary table may be first randomly initialized as a vector, and the vector corresponding to each word is optimized by using a relatively large monolingual corpus as training data, so that words having a same or similar meaning are represented by using similar vectors. For example, each word in the foregoing vocabulary table (we, I, love, China) may be first randomly initialized as one vector. For example, the word we is randomly initialized as a vector and the vector of the word we is assigned as (0.00001, −0.00001, 0.0005, 0.0003). Further, the monolingual corpus may be used as the training data to optimize the vector through feature learning, and vector representation related to a meaning of a word is obtained through learning. For example, through feature learning of the neural network, a vector of the word we is represented as (0.7, 0.9, 0.5, 0.3), and a vector of the word I is represented as (0.6, 0.9, 0.5, 0.3). From a vector perspective, the two words are very close, indicating that the two words have a similar meaning. If a vector of the word love is represented as (−0.5, 0.3, 0.1, 0.2), it can be directly learned that meanings of the word love and the words we and I are not close.

In an implementation, when the vector corresponding to each word is trained by using the relatively large monolingual corpus as the training data, a segment phr+ with a window size of n (in FIG. 2, a window size is 4, and a segment is “cat sat on the mat”) may be randomly selected from the training data as a positive example. The window size is a quantity of left and right words of a current word. For example, in FIG. 2, a current word is on, and the window size is 4, indicating that two words on the left and two words on the right are taken: cat and sat, and the and mat. A word vector corresponding to the segment phr+ is spliced as an input layer of the neural network, and a score f+ is obtained after the vector passes through a hidden layer. The score f+ indicates that the segment is a normal natural language segment. For example, if a vector that is input into the input layer of the neural network is “cat sat on the mat”, a score 0.8 of the vector is output after the vector passes through the hidden layer of the neural network. 0.8 may be denoted as f+, indicating that an expression “cat sat on the mat” is a commonly used language form, and “cat sat on the mat” may be defined as a natural language segment. If a vector that is input into the input layer of the neural network is “cat sat on the beat”, a score 0.1 of the vector is output after the vector passes through the hidden layer of the neural network. 0.1 may be denoted as f−, indicating that an expression “cat sat on the mat” is an uncommonly used language form, and “cat sat on the beat” may be defined as a non-natural language segment. Whether “cat sat on the mat” or “cat sat on the beat” is a commonly used language form may be determined by using a quantity of appearance times of the vector in the training data. If the quantity of appearance times of the vector in the training data is greater than a preset threshold, the vector may be determined as a commonly used language form. If the quantity of appearance times of the vector in the training data is not greater than the preset threshold, the vector may be determined as an uncommonly used language form.

Further, during training, a word in the middle of a window may be randomly replaced with another word in the vocabulary table, a segment phr− in a negative example is obtained in the foregoing same manner, and further a score f− in the negative example is obtained. The positive example indicates that a vector corresponding to the segment phr+ is a commonly used language form, and the negative example may be obtained after a location of a word in the segment in the commonly used language form randomly changes. In the negative example, the segment phr− indicates that a vector corresponding to the segment phr− is an uncommonly used language form. In an implementation, a loss function for determining the positive example and the negative example at the hidden layer may be defined as a ranking hinge loss (English: ranking hinge loss), and the loss function enables the score f+ in the positive example to be greater than the score f− in the negative example by at least 1. A gradient is obtained by taking a derivative of the loss function, a parameter at each layer of the neural network is learned through back propagation, and in addition, word vectors in positive and negative example samples are updated. Such a training method can aggregate words that are suitable for appearing at the middle location of the window, and separate words that are not suitable for appearing at this location, so that semantically (in terms of grammar or part of speech) similar words are mapped to close locations in vector space. For example, if “on the mat” is replaced with “on the beat”, a score difference may be large, while a score of “on the mat” and a score of “on the sofa” are very close (a score obtained by the neural network through learning). Through score comparison, it can be learned that meanings of “mat” and “sofa” are very similar, but meanings of “mat” and “beat” are very different, and therefore different vectors are correspondingly assigned to these words for representation.

Because it is easier to obtain large scale monolingual data, vectorization representation of a neural network training vocabulary is highly feasible and has a wide application range, and a problem of data sparsity caused by insufficient training data of a specific task is resolved.

In some implementations, after determining the character sequence included in the unknown word and inputting the character sequence into the first multi-layer neural network, the unknown word processing apparatus may determine the character vector of each character in the character sequence based on the foregoing vector representation method by using the first multi-layer neural network, in other words, may obtain the character vector of each character in the unknown word, and may further input character vectors of all characters in the character sequence into the second multi-layer neural network. For example, the unknown word processing apparatus may separately obtain a character vector A1 of “ [symbol] ”, a character vector A2 of “ [symbol] ”, a character vector A3 of “ [symbol] ”, a character vector A4 of “ [symbol] ”, and a character vector A5 of “ [symbol] ” in the foregoing character sequence by using the first multi-layer neural network, and may further input A1, A2, A3, A4, and A5 into the second multi-layer neural network.

S104. Encode all the character vectors by using the second multi-layer neural network and a preset common word database, to obtain a semantic vector corresponding to the character sequence.

In some implementations, the common word database provided in this embodiment of the present disclosure may include a dictionary, a linguistic rule, a cyberword database, and the like. The dictionary, the linguistics rule, or the cyberword database may provide vocabulary information for the second multi-layer neural network, and the vocabulary information may be used to determine a word combination manner between characters. In an implementation, the unknown word processing apparatus may add the common word database to a process of using the second multi-layer neural network for encoding. The unknown word processing apparatus may perform literal parsing on each character vector in the character sequence by using the second multi-layer neural network, determine a combination manner of character vectors in the character sequence based on the vocabulary information included in the common word database, and further generate the plurality of semantic vectors corresponding to the foregoing character sequence. The character vectors included in the character sequence may be combined in a plurality of manners, and a character vector combination determined by each combination manner corresponds to one meaning. If the character sequence includes only one character vector, there is only one meaning of the character vector combination of the character sequence. If the character sequence includes a plurality of character vectors, there is more than one meaning of the character vector combination of the character sequence. Further, one or more meanings determined by one or more character vector combinations of the character sequence may be compression encoded by using the second multi-layer neural network, to obtain the semantic vector of the character sequence.

In an implementation, if there is no common word database when the unknown word apparatus performs literal parsing on each character vector by using the second multi-layer neural network, the unknown word apparatus determines that a combination manner of the character vectors is a pairwise combination of the character vectors. There are a large quantity of combinations obtained from the pairwise combination of the character vectors in the character sequence, there are many meanings corresponding to the character vector combination, and there are many meanings of the semantic vector obtained by compression encoding, by the second multi-layer neural network, a meaning of the character vector combination determined through the pairwise combination of the character vectors. Consequently, noise of decoding a meaning of the semantic vector is increased, and difficulty of determining the meaning of the semantic vector is increased. In this embodiment of the present disclosure, when the common word database is provided for the second multi-layer neural network to determine a combination manner of character vectors of each character sequence, the combination manner of each character sequence may be determined according to a word combination rule or a common word in the common word database, and is no longer a simple pairwise combination. A quantity of character vector combinations that are determined by the combination manner of the character vectors determined by using the common word database is less than a quantity of character vector combinations determined by the pairwise combination of the character vectors, and word combination accuracy is high, reducing noise of determining the meaning of the semantic vector corresponding to the character sequence.

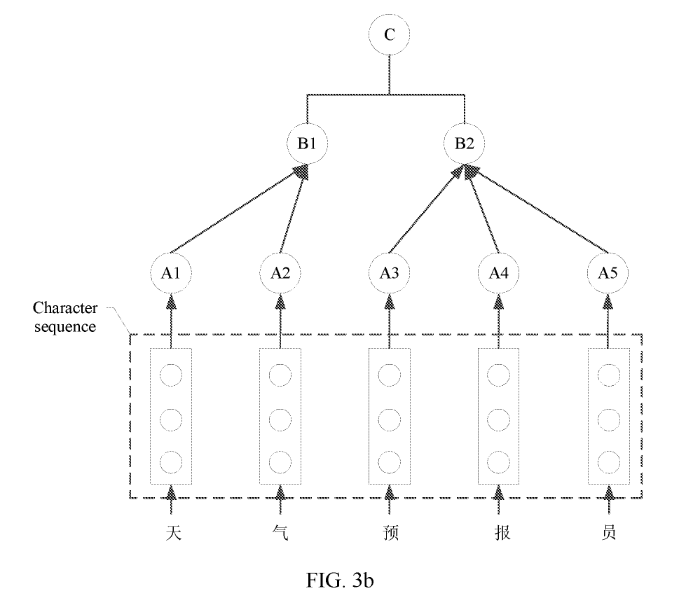

FIG. 3a is a schematic diagram of determining a semantic vector by using a plurality of character vectors, and FIG. 3b is another schematic diagram of determining a semantic vector by using a plurality of character vectors. FIG. 3a shows a combination manner of character vectors in a character sequence in a conventional multi-layer neural network, to be specific, a connection between each vector and an upper-layer node is a full connection. For example, character vectors A1, A2, A3, A4, and A5 of the foregoing character sequence “ [symbol] ” are all connected to upper-layer nodes B1 and B2 in a full connection manner, any combination manner of the character vectors such as “ [symbol] ”, “ [symbol] ”, “ [symbol] ”, “ [symbol] ”, and “ [symbol] ” may be further obtained, and a semantic vector C corresponding to the foregoing five character vectors is obtained by using the upper-layer nodes B1 and B2. A meaning included in the semantic vector C is a meaning of each character vector combination obtained by arbitrarily combining the foregoing five character vectors. A meaning that does not conform to a common word combination manner is included, for example, [symbol] and [symbol] , where [symbol] is a common word, but [symbol] is an uncommon word. FIG. 3b shows a customized multi-layer neural network for establishing a connection by using a common word database according to an embodiment of the present disclosure. For a combination manner of character vectors corresponding to a character sequence in the customized multi-layer neural network, refer to words included in the foregoing common word database. This can reduce appearance of an uncommon word and reduce an appearance probability of noise. For example, character vectors A1, A2, A3, A4, and A5 of the foregoing character sequence “ [symbol] ” are connected to upper-layer nodes B1 and B2 in a directed manner, a common word combination manner of characters such as “ [symbol] ”, “ [symbol] ”, “ [symbol] ”, “ [symbol] ”, and “ [symbol] ” may be further obtained, a combination manner of the foregoing character vectors A1, A2, A3, A4, and A5 is determined based on the foregoing common word combination manner, and a semantic vector C corresponding to the foregoing five character vectors is obtained by using the upper-layer nodes B1 and B2. A meaning included in the semantic vector C is a meaning corresponding to each character vector combination determined based on the common word combination manner of the foregoing five character vectors, for example, “ [symbol] ”, “ [symbol] ”, or the like constituted by “ [symbol] ” and “ [symbol] [symbol] ”.

S105. Input the semantic vector into a third multi-layer neural network, decode the semantic vector by using the third multi-layer neural network, and determine a final translation of the to-be-translated sentence based on the initial translation of the to-be-translated sentence.

In some implementations, the semantic vector corresponding to the foregoing character sequence is a vector that includes a plurality of types of semantics, to be specific, the semantic vector is a vector that includes a plurality of meanings corresponding to a plurality of character vector combinations determined by a plurality of combination manners that are of a plurality of character vectors in the foregoing character sequence and that are determined based on the common word database. A specific meaning of the semantic vector may be determined based on a context of a sentence in which the semantic vector is located. For example, for a polysemant in a common word, meanings of the polysemant in different sentences or in different locations of a same sentence are different, and a specific meaning may be determined based on a context of a sentence.

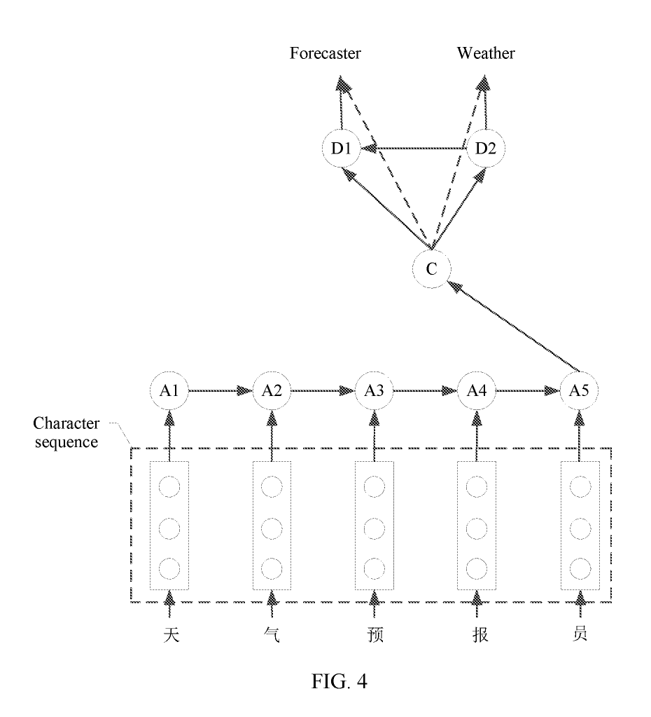

In some implementations, after determining the semantic vector, the unknown word processing apparatus may input the semantic vector into the third multi-layer neural network, decode the semantic vector by using the third multi-layer neural network, and determine the final translation of the to-be-translated sentence based on the initial translation of the to-be-translated sentence. The unknown word processing apparatus may decode the semantic vector of the unknown word by using the third multi-layer neural network, determine one or more meanings included in the semantic vector, determine a specific meaning (namely, a target meaning) of the semantic vector of the unknown word based on a meaning included in the semantic vector of the unknown word and a context meaning of the unknown word in the initial translation of the to-be-translated sentence, and further determine the final translation of the to-be-translated sentence based on a context translation of the unknown word. The final translation carries a translation of the unknown word and the context translation of the unknown word. FIG. 4 is a schematic diagram of translation processing of an unknown word. The unknown word processing apparatus may obtain the character vectors A1, A2, A3, A4, and A5 of the character sequence “ [symbol] [symbol] ” by using the first multi-layer neural network, determine, by using the second multi-layer neural network, the semantic vector C determined by using the character vectors A1, A2, A3, A4, and A5, decode the semantic vector C to obtain two meanings D1 and D2, and further determine the meaning of the unknown word based on Dl and D2. The foregoing D1 may be “forecaster”, and the foregoing D2 may be “weather.” After translating the unknown word “ [symbol] ” to obtain “forecaster” and “weather”, the unknown word processing apparatus may use “forecaster” and “weather” to replace a raw output of “ [symbol] ” or an unknown output in the initial translation, to obtain the final translation of the to-be-translated sentence.

It should be noted that the first multi-layer neural network, the second multi-layer neural network, and the third multi-layer neural network described in this embodiment of the present disclosure are a plurality of multi-layer neural networks having different network parameters, and can implement different functions to jointly complete translation processing of an unknown word.

In this embodiment of the present disclosure, the unknown word processing apparatus may split the unknown word in the to-be-translated sentence into the character, use the character to constitute the character sequence, and obtain the character vector of each character in the character sequence through processing of the first multi-layer neural network. Further, the unknown word processing apparatus may compression encode the plurality of character vectors in the character sequence based on the common word database by using the second multi-layer neural network, to obtain the semantic vector of the character sequence, and decode the semantic vector by using the third multi-layer neural network, to obtain the translation of the unknown word. According to the translation method described in this embodiment of the present disclosure, translation operability of an unknown word can be improved, costs of machine translation can be reduced, accuracy of machine translation can be improved, and further translation quality can be improved.

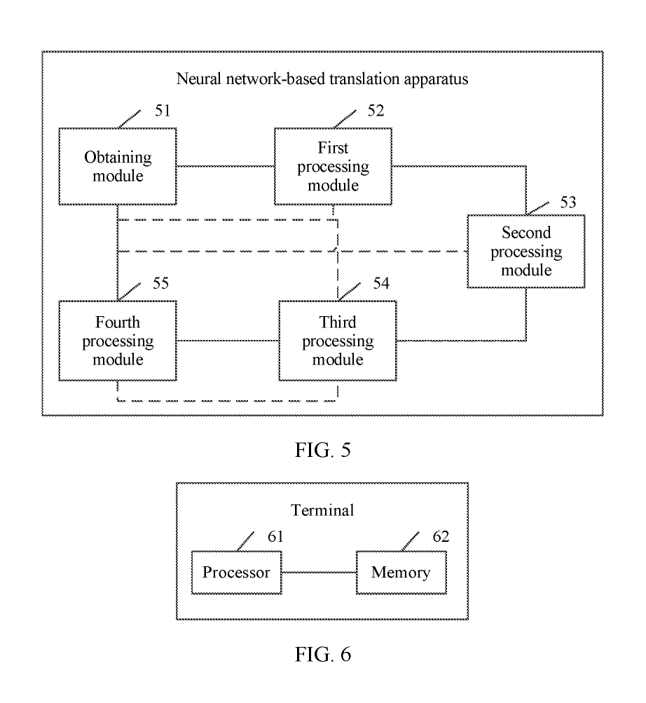

FIG. 5 is a schematic structural diagram of a neural network-based translation apparatus according to an embodiment of the present disclosure. The translation apparatus provided in this embodiment of the present disclosure includes:

an obtaining module 51, configured to obtain an initial translation of a to-be-translated sentence, where the initial translation carries an unknown word;

a first processing module 52, configured to: split the unknown word in the initial translation obtained by the obtaining module into one or more characters, and input, into a first multi-layer neural network, a character sequence constituted by the one or more characters that is obtained by splitting the unknown word, where the character sequence includes at least one character;

a second processing module 53, configured to: obtain, by using the first multi-layer neural network, a character vector of each character in the character sequence input by the first processing module, and input all character vectors in the character sequence into a second multi-layer neural network;

a third processing module 54, configured to: encode, by using the second multi-layer neural network and a preset common word database, all the character vectors input by the second processing module, to obtain a semantic vector corresponding to the character sequence; and

a fourth processing module 55, configured to: input the semantic vector obtained by the third processing module into a third multi-layer neural network, decode the semantic vector by using the third multi-layer neural network, and determine a final translation of the to-be-translated sentence based on the initial translation of the to-be-translated sentence, where the final translation carries a translation of the unknown word.

In some implementations, the preset common word database includes at least one of a dictionary, a linguistics rule, and a cyberword database.

In some implementations, the third processing module 54 is configured to:

determine at least one combination manner of the character vectors in the character sequence by using the second multi-layer neural network based on vocabulary information provided by the common word database, where a character vector combination determined by each combination manner corresponds to one meaning; and

compression encode at least one meaning of at least one character vector combination determined by the at least one combination manner, to obtain the semantic vector.

In some implementations, the fourth processing module 55 is configured to:

decode, by using the third multi-layer neural network, the semantic vector obtained by the third processing module, to determine at least one meaning included in the semantic vector, and select, based on a context meaning of the unknown word in the initial translation, a target meaning from the at least one meaning included in the semantic vector; and

determine the final translation of the to-be-translated sentence based on the target meaning and the context meaning of the unknown word in the initial translation.

In some implementations, the unknown word includes at least one of an abbreviation, a proper noun, a derivative, and a compound word.

In an implementation, the translation apparatus can implement, by using each built-in module of the translation apparatus, an implementation described in each operation of the neural network-based translation method provided in the embodiments of the present disclosure. Details are not described herein again.

In this embodiment of the present disclosure, the translation apparatus may split the unknown word in the to-be-translated sentence into the character, use the character to constitute the character sequence, and obtain the character vector of each character in the character sequence through processing of the first multi-layer neural network. Further, the translation apparatus may compression encode a plurality of character vectors in the character sequence based on the common word database by using the second multi-layer neural network, to obtain the semantic vector of the character sequence, and decode the semantic vector by using the third multi-layer neural network, to obtain the translation of the unknown word. This embodiment of the present disclosure can improve translation operability of an unknown word, reduce costs of machine translation, improve accuracy of machine translation, and further improve translation quality.

FIG. 6 is a schematic structural diagram of a terminal according to an embodiment of the present disclosure. The terminal provided in this embodiment of the present disclosure includes a processor 61 and a memory 62, and the processor 61 is connected to the memory 62.

The memory 62 is configured to store a group of program code.

The processor 61 is configured to invoke the program code stored in the memory 62, to perform the following operations:

obtaining an initial translation of a to-be-translated sentence, where the initial translation carries an unknown word;

splitting the unknown word in the initial translation into one or more characters, and inputting, into a first multi-layer neural network, a character sequence constituted by the one or more characters that is obtained by splitting the unknown word, where the character sequence includes at least one character;

obtaining a character vector of each character in the character sequence by using the first multi-layer neural network, and inputting all character vectors in the character sequence into a second multi-layer neural network;

encoding all the character vectors by using the second multi-layer neural network and a preset common word database, to obtain a semantic vector corresponding to the character sequence; and

inputting the semantic vector into a third multi-layer neural network, decoding the semantic vector by using the third multi-layer neural network, and determining a final translation of the to-be-translated sentence based on the initial translation of the to-be-translated sentence, where the final translation carries a translation of the unknown word.

In some implementations, the preset common word database includes at least one of a dictionary, a linguistics rule, and a cyberword database.

In some implementations, the processor 61 is configured to:

determine at least one combination manner of the character vectors in the character sequence by using the second multi-layer neural network based on vocabulary information provided by the common word database, where a character vector combination determined by each combination manner corresponds to one meaning; and

compression encode at least one meaning of at least one character vector combination determined by the at least one combination manner, to obtain the semantic vector.

In some implementations, the processor 61 is configured to:

decode the semantic vector by using the third multi-layer neural network, to determine at least one meaning included in the semantic vector, and select, based on a context meaning of the unknown word in the initial translation, a target meaning from the at least one meaning included in the semantic vector; and determine the final translation of the to-be-translated sentence based on the target meaning and the context meaning of the unknown word in the initial translation.

In some implementations, the unknown word includes at least one of an abbreviation, a proper noun, a derivative, and a compound word.

In an implementation, the terminal can implement, by using each built-in module of the terminal, an implementation described in each operation of the neural network-based translation method provided in the embodiments of the present disclosure. Details are not described herein again.

In this embodiment of the present disclosure, the terminal may split the unknown word in the to-be-translated sentence into the character, use the character to constitute the character sequence, and obtain the character vector of each character in the character sequence through processing of the first multi-layer neural network. Further, the terminal may compression encode a plurality of character vectors in the character sequence based on the common word database by using the second multi-layer neural network, to obtain the semantic vector of the character sequence, and decode the semantic vector by using the third multi-layer neural network, to obtain the translation of the unknown word. This embodiment of the present disclosure can improve translation operability of an unknown word, reduce costs of machine translation, improve accuracy of machine translation, and further improve translation quality.

In the specification, claims, and accompanying drawings of the present disclosure, the terms “first”, “second”, “third”, “fourth”, and so on are intended to distinguish between different objects but do not indicate a particular order. Moreover, the terms “including”, “comprising”, and any other variant thereof, are intended to cover a non-exclusive inclusion. For example, a process, a method, a system, a product, or a device that includes a series of operations or units is not limited to the listed operations or units, but optionally further includes an unlisted operation or unit, or optionally further includes another inherent operation or unit of the process, the method, the system, the product, or the device.

A person of ordinary skill in the art may understand that all or some of the processes of the methods in the embodiments may be implemented by a computer program instructing relevant hardware. The program may be stored in a computer-readable storage medium. When the program runs, the processes of the methods in the embodiments are performed. The foregoing storage medium may include: a magnetic disk, an optical disc, a read-only memory (ROM), or a random access memory (RAM).

What are disclosed above are merely examples of embodiments of the present disclosure, and certainly are not intended to limit the scope of the claims of the present disclosure. Therefore, equivalent variations made in accordance with the claims of the present disclosure shall fall within the scope of the present disclosure.

What is claimed is:

1. A neural network-based translation method, comprising:
obtaining an initial translation of a to-be-translated sentence, wherein the initial translation carries an unknown word;
splitting the unknown word in the initial translation into one or more characters, and inputting, into a first multi-layer neural network, a character sequence constituted by the one or more characters that is obtained by splitting the unknown word;
obtaining a character vector of each character in the character sequence by using the first multi-layer neural network, and inputting all character vectors in the character sequence into a second multi-layer neural network;
encoding all the character vectors by using the second multi-layer neural network and a preset common word database, to obtain a semantic vector corresponding to the character sequence; and
inputting the semantic vector into a third multi-layer neural network, decoding the semantic vector by using the third multi-layer neural network, and determining a final translation of the to-be-translated sentence based on the initial translation of the to-be-translated sentence, wherein the final translation carries a translation of the unknown word.

2. The translation method according to claim 1, wherein the preset common word database comprises at least one of a dictionary, a linguistics rule, and a cyberword database.

3. The translation method according to claim 1, wherein the encoding all the character vectors by using the second multi-layer neural network and the preset common word database, to obtain the semantic vector corresponding to the character sequence comprises:
determining at least one combination manner of the character vectors in the character sequence by using the second multi-layer neural network based on vocabulary information provided by the common word database, wherein a character vector combination determined by each combination manner corresponds to one meaning; and
compression decoding at least one meaning of at least one character vector combination determined by the at least one combination manner, to obtain the semantic vector.

4. The translation method according to claim 3, wherein the decoding the semantic vector by using the third multi-layer neural network, and determining a final translation of the to-be-translated sentence based on the initial translation of the to-be-translated sentence comprises:
decoding the semantic vector by using the third multi-layer neural network, to determine at least one meaning comprised in the semantic vector, and selecting, based on a context meaning of the unknown word in the initial translation, a target meaning from the at least one meaning comprised in the semantic vector; and
determining the final translation of the to-be-translated sentence based on the target meaning and the context meaning of the unknown word in the initial translation.

5. The translation method according to claim 1, wherein the unknown word comprises at least one of an abbreviation, a proper noun, a derivative, and a compound word.

6. A neural network-based translation apparatus, comprising:
an obtaining module, configured to obtain an initial translation of a to-be-translated sentence, wherein the initial translation carries an unknown word;
a first processing module, configured to: split the unknown word in the initial translation obtained by the obtaining module into one or more characters, and input, into a first multi-layer neural network, a character sequence constituted by the one or more characters that is obtained by splitting the unknown word;
a second processing module, configured to: obtain, by using the first multi-layer neural network, a character vector of each character in the character sequence input by the first processing module, and input all character vectors in the character sequence into a second multi-layer neural network;
a third processing module, configured to: encode, by using the second multi-layer neural network and a preset common word database, all the character vectors input by the second processing module, to obtain a semantic vector corresponding to the character sequence; and
a fourth processing module, configured to: input the semantic vector obtained by the third processing module into a third multi-layer neural network, decode the semantic vector by using the third multi-layer neural network, and determine a final translation of the to-be-translated sentence based on the initial translation of the to-be-translated sentence, wherein the final translation carries a translation of the unknown word.

7. The translation apparatus according to claim 6, wherein the preset common word database comprises at least one of a dictionary, a linguistics rule, and a cyberword database.

8. The translation apparatus according to claim 6, wherein the third processing module is configured to:
determine at least one combination manner of the character vectors in the character sequence by using the second multi-layer neural network based on vocabulary information provided by the common word database, wherein a character vector combination determined by each combination manner corresponds to one meaning; and
compression encode at least one meaning of at least one character vector combination determined by the at least one combination manner, to obtain the semantic vector.

9. The translation apparatus according to claim 8, wherein the fourth processing module is configured to:
decode, by using the third multi-layer neural network, the semantic vector obtained by the third processing module, to determine at least one meaning comprised in the semantic vector, and select, based on a context meaning of the unknown word in the initial translation, a target meaning from the at least one meaning comprised in the semantic vector; and
determine the final translation of the to-be-translated sentence based on the target meaning and the context meaning of the unknown word in the initial translation.

10. The translation apparatus according to claim 6, wherein the unknown word comprises at least one of an abbreviation, a proper noun, a derivative, and a compound word.

11. A neural network-based translation apparatus, comprising: a memory and a processor, wherein the memory is configured to store program code and the processor is configured to invoke the program code stored in the memory, to perform the method according to claim 1.
